(19) United States
(12) Patent Application Publication
(10) Pub. No.: US 2002/0132212 A1
(43) Pub. Date: Sep. 19, 2002

(54) Multi-functional portable information learning device

(76) Inventor: Andrew Hou, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/805,059

(22) Filed: Mar. 14, 2001

(51) Int. Cl. G10H 1/36

(52) U.S. Cl. 434/307 A

(57) ABSTRACT

A multi-functional portable information learning device comprises a seat, a machine body, a circuit control unit. The seat is installed with a receptacle for being connected to a connector at a bottom of the machine body. The tilt portion receptacle is connected to a connecting seat. The connecting seat is connected to a computer through a universal series bus transmission line. The machine body is installed with a operation key set, a lateral key set, a liquid crystal window, a multimedia memory extension slot. A circuit control unit is installed within the machine body. The circuit control unit is connected to a connector, a liquid crystal window, a operation key set, a lateral key set, and the multimedia memory extension slot. Thereby, the voice and text are displayed synchronously and text or music is uploaded or downloaded or synchronously for enhancing language learning effect and extending memory.

### FIELD OF THE INVENTION

The present invention relates to a multi-functional portable information learning device, and especially to a synchronous learning device combined with the functions of language learning, MP3 music, Kala OK music, dictionary, and others.

### BACKGROUND OF THE INVENTION

Since the development in the network information, there are many products about personal information applications, such as personal digital assistants (PDA), MP3 music players, or language learning machines, etc. However, many devices with different functions are inconvenient in carrying. Therefore, a novel device capable of integrating above devices is advantageous to consumers.

However, no device can integrate an MP3 music and voiced book or other files so as to present to the user synchronously. That is, the device has the function of MP3 music player and dictionaries of various languages, such as English-Chinese dictionary. Thereby, the user may carry it conveniently and in using, multi-function can be presented to the user so as to enhance the learning and amusement effect.

### SUMMARY OF THE INVENTION

Accordingly, the primary object of the present invention is to provide a multi-functional portable information learning device which combines the functions of amusement, learning and information. A hardware is matched with internal program, so that the user may receive MP3 music with text being displayed on the liquid crystal window. Furthermore, other software programs, such as English teaching, voice book, Kala OK can be downloaded from a computer for being played.

Another object of the present invention is to provide a multi-functional portable information learning device combined with the functions of language learning, MP3 music, Kala OK music, dictionary, and others. Therefore, the user may check English words at any time, and enhances the learning effect of languages. The present invention is different from the commercial MP3 music device. Other than playing music, the present invention can be used to download any data from a network, for example a voice book. Therefore, the present invention has the effects of learning and amusement.

A further object of the present invention is to provide a multi-functional portable information learning device combined with the functions of language learning, MP3 music, Kala OK music, dictionary, and others. The present invention is installed with flash memory and multimedia memory extension slot, thus the memory capacity can be expanded. As such, the present invention can be used as a portable hard disk, and thereby, the icons on the screen can be checked and selected rapidly.

The various objects and advantages of the present invention will be more readily understood from the following detailed description when read in conjunction with the appended drawing.

### BRIEF DESCRIPTION OF THE DRAWINGS

FIG. 1 is a perspective view of the present invention.

FIG. 2 is an exploded view of the present invention.

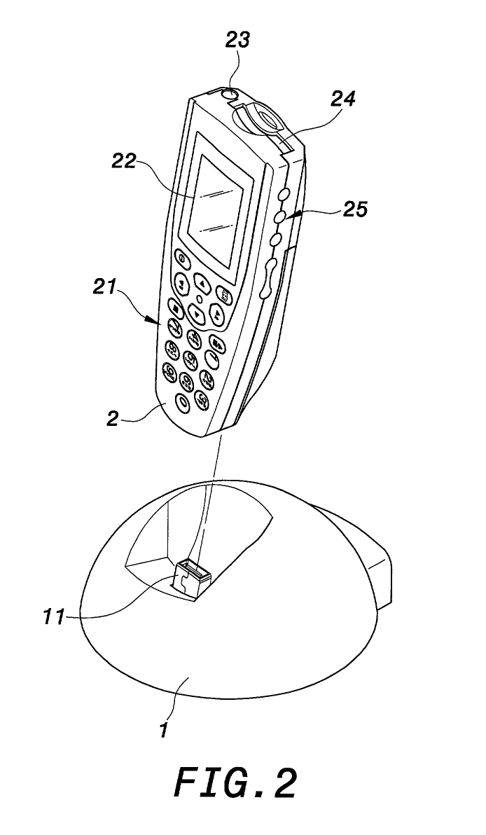

FIG. 3 is a partial schematic view of the machine body of the present invention.

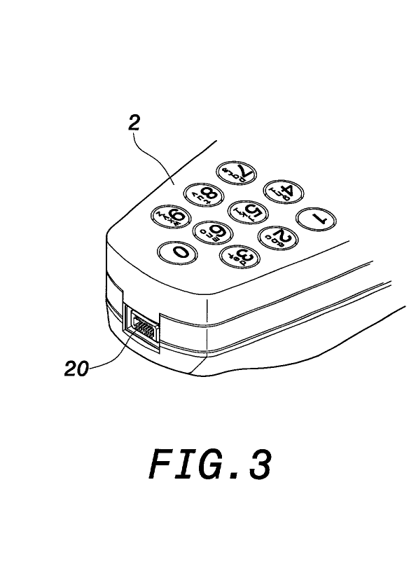

FIG. 4 shows the construction of the present invention.

FIG. 5 shows a block diagram of the circuit control unit according to the present invention.

### DETAILED DESCRIPTION OF THE PREFERRED EMBODIMENTS

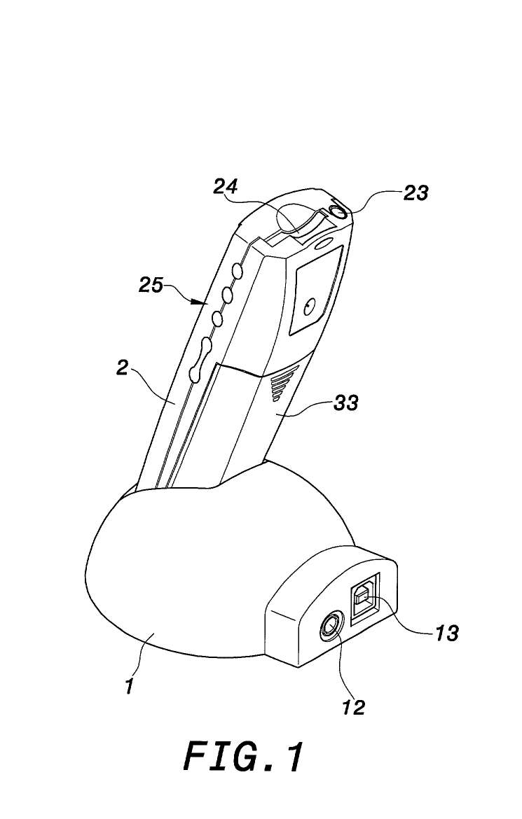

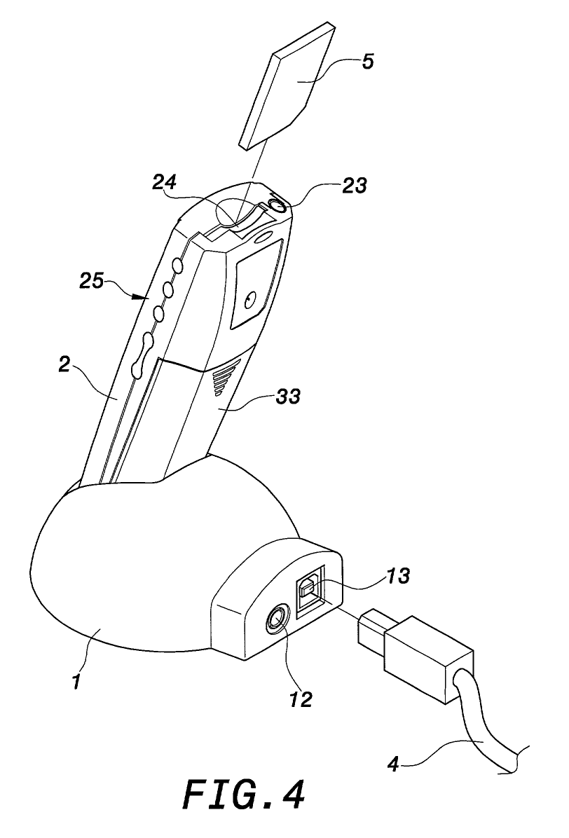

With reference to FIGS. 1 and 4, the personal multi-functional portable information learning device of the present invention is illustrated. The multi-functional portable information learning device can be combined with the function of language learning, MP3 music, Kala OK music, dictionary, and others. The multi-functional portable information learning device includes a seat 1 and a machine body 2. The seat 1 has a hemispherical shape and is installed with a receptacle 11 for being combined with a connector 20 at a lower end of the machine body 2. One side of the seat 1 is installed with an earphone seat 12 for being disposed with a terminal of an earphone line or a trumpet line. A connecting seat 13 is installed adjacent to the earphone seat 12 and is connected to the receptacle 11. The connecting seat 13 can be connected to a universal series bus transmission line 4 so as to be further connected to a computer. As such, the circuit control unit in the machine body 2 can be transmitted synchronous with a computer (not shown), such as operation of recording a standby data in the computer, or transferring data to the machine body 2 from a computer.

The front panel of the machine body 2 is installed with a operation key set 21. The operation key set 21 includes catalog keys, a power key, direction keys, Play/Pause key, escape key (ESC), alphanumerical input keys about numerical/English-Chinese dictionary. The alphanumerical input keys about numerical/English-Chinese dictionary assists the user to select menu easily and is employed to check English-Chinese dictionary. A liquid crystal window 22 is installed on the operation key set 21 for displaying the current operation condition of the machine body 2, such as power capacity of batteries, playing or dump data, etc. A side adjacent to the liquid crystal window 22 is installed with an earphone seat 23 for being inserted by the terminal of an earphone line. The side adjacent to the earphone seat 23 is installed with an extension slot 25 for multimedia memory cards. Thereby, an MMC memory card 5 can be pushed and engaged therein according to the direction illustrated by an arrow shown in the figure.

One lateral side adjacent to the machine body 2 is installed with a lateral key set 25 which installed with Play/Replay keys, A/B replay keys (segment repeat or whole repeat), sound field set keys or a volume control key. The sound field setting functions provide the functions of Classic, Jazz, Rock and Live music so that different music has different representation and the original sound can be presented. Furthermore, through the functions of volume control, bass, TREL waveform, the detail portion of the music is presented completely. A circuit control unit is installed in the machine body 2. A battery cover 33 is mounted at a back panel of the machine body 2. A battery set is installed in the battery cover 33 for supplying power to the circuit control unit.

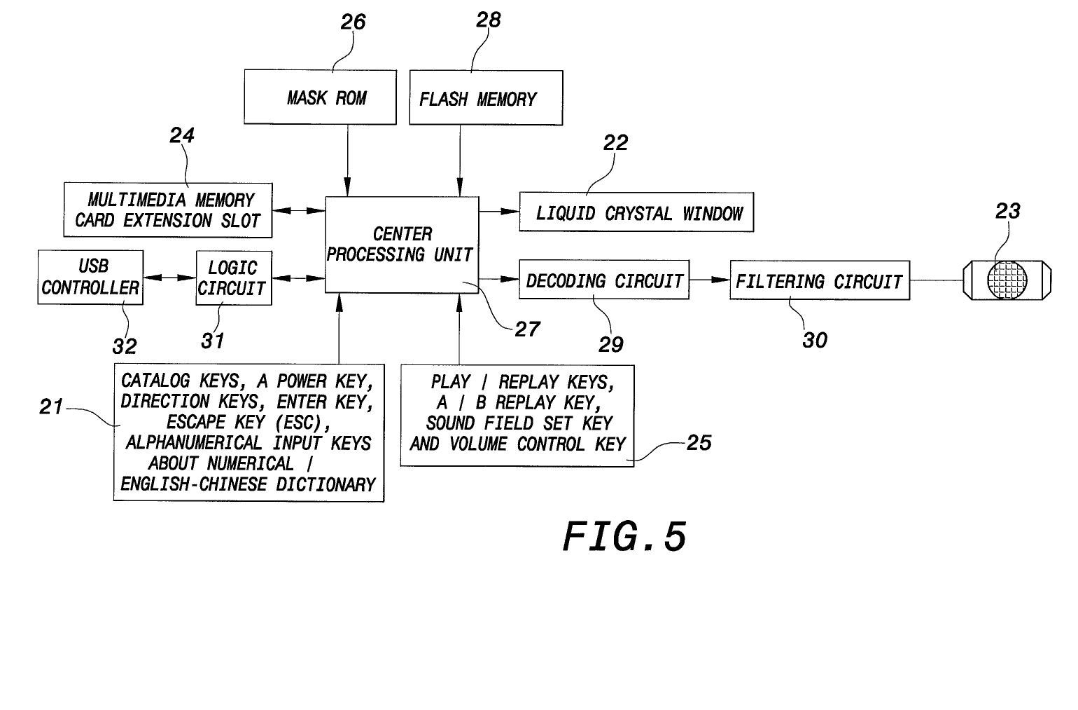

Referring to FIG. 5, the circuit control unit is mounted with a mask ROM 26 for accessing a program. The mask ROM 26 is connected to a center processing unit 27. The center processing unit 27 executes respective functions according to the operation key set 21 or the lateral key set 25. The center processing unit 27 is connected to a flash memory 28 for accessing the sound or music or text files downloaded from a computer. An output port of the center processing unit 27 is connected to a decoding circuit 29 for decoding audio signals outputted from the center processing unit 27. An output of the decoding circuit 29 is connected to a filtering circuit 30. An output of the filtering circuit 30 is connected to the earphone seat 23. The filtering circuit 30 serves to filter the noise from the decoding signal. Then, the signal filtered is outputted to the earphone seat 23 to be presented as music or speech for being received by the user.

The center processing unit 27 is connected to a universal series bus control 32 through a logic circuit 31. The universal series bus control 32 is communicated with the connector 20.

When the machine body 2 dumps MP3 music or text files (such as voice book, English learning, etc) from a computer. The music and text file will be integrated and then are converted into a file with MPX format. Then it is stored to the flash memory 28 or the plug-in multimedia memory card 5.

Now, if a user selects a synchronous (sync) mode in the icons of the liquid crystal window 22. The user may contrast the voice with the text. If the user touches a Pause key on the front panel, and then presses a numeral key “1”, voices and respective texts are displayed synchronously on the screen of the liquid crystal window 22. Then, the meaning of the aforesaid text can be checked at any time so as to achieve an effect of multi-channel.

If the user clicks an numeral key “0” and then presses an escape key (ESC), then the key set is locked from being touched by a mistake. If the operation is repeated, then the lock condition is released. The key locking function provides a protection from an undesired touch as exercising or as the device is placed in a pocket. Therefore, as the user hears a music, by this function, the user do not worry about that the music will be interrupted.

If the user presses the A/B replay function on the front panel, then the user may hear music or speech of the same segment.

If the user selects a Kala OK function from the icons of the liquid crystal window 22 (in which, a learning or amusement process is executed by separating the music from text), then the user may receive music or amusement. Furthermore, the related operation information is displayed on liquid crystal window 22.

If the user presses the function of English-Chinese dictionary on the icons of the liquid crystal window 22, then the user may input alpha keys to check the phonetic signs, syntactical feature, Chinese meanings.

In summary, the multi-functional portable information learning device of the present invention has the following advantages:

1. Multi-functions.

2. Text/Voice is displayed synchronously, thereby, as the user plays an MP3 music, the respective text message can be displayed on the liquid crystal window.

3. Easy operation.

4. Presenting a vivid effect through sounds and texts. Furthermore, a real-time English-Chinese dictionary provides a convenient leaning environment to the consumers.

5. A portable palm type device is provided.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A multi-functional portable information learning device having functions of being combined with at least one function selecting from a group containing language learning, MP3 music, Kala OK music, dictionary, and the likes comprising:
a seat having a receptacle for being combined with a connector and being connected to a connecting seat; the connecting seat being communicated with a computer through a transmission line;
a machine body having a display unit, a operation key set, a lateral key set, and a slot for being inserted by a multimedia memory card (MMC); and a lower side of the machine body being installed with a connector for being connected to the receptacle on the connecting seat;
a circuit control unit mounted in the machine body; and being installed with a second memory unit for accessing a program; the second memory unit being connected to a center processing unit; the center processing unit being connected to a second memory unit for accessing music or text files downloaded from a computer; an output of the center processing unit being connected to a voice driving unit for decoding a voice signal outputted from the center processing unit and filtering noises from the decoding signal; the center processing unit being connected to an interface controller; the interface controller being communicated with the connector; and the center processing unit being connected with the display unit and operation key set; the circuit control unit executing respective operations according to an input of the operation key set; and
a power unit for supplying power to the circuit control unit;
wherein voices and texts are displayed synchronously and text or music is uploaded or downloaded or synchronously for enhancing language learning effect and extending memory.

2. The multi-functional portable information learning device as claimed in claim 1, wherein the connector is a universal series bus connector.

3. The multi-functional portable information learning device as claimed in claim 1, wherein an earphone seat is installed on the seat for being connected to the receptacle.

4. The multi-functional portable information learning device as claimed in claim 1, wherein the operation key set includes catalog keys, a power key, direction keys, Play/Pause keys, an escape key (ESC), alphanumerical input keys, numerical/English-Chinese dictionary keys, Play/Replay keys, A/B replay keys, sound field set keys and a volume control key.

5. The multi-functional portable information learning device as claimed in claim 1, wherein the machine body is installed with an earphone seat for being connected to a voice driving circuit.

6. The multi-functional portable information learning device as claimed in claim 1, wherein the voice driving circuit is formed by a decoding circuit and a filtering circuit.

7. The multi-functional portable information learning device as claimed in claim 1, wherein a logic circuit is connected between the center processing unit and the interface controller.

8. The multi-functional portable information learning device as claimed in claim 1, wherein the display unit is a liquid crystal display.

9. The multi-functional portable information learning device as claimed in claim 1, wherein the first memory is a flash memory or a mask ROM.

10. The multi-functional portable information learning device as claimed in claim 1, wherein the second memory unit is a flash memory.
